(19) United States
(12) Patent Application Publication
(10) Pub. No.: US 2014/0375211 A1
(43) Pub. Date: Dec. 25, 2014

(54) LED DRIVER

(71) Applicants: Felipe A. Herrador, Los Banos, CA (US); Monica A. Herrador, Los Banos, CA (US)

(72) Inventors: Felipe A. Herrador, Los Banos, CA (US); Monica A. Herrador, Los Banos, CA (US)

(21) Appl. No.: 13/921,210

(22) Filed: Jun. 19, 2013

(51) Int. Cl. H05B 33/08

(52) U.S. Cl. CPC H05B 33/0809; H05B 33/0884
USPC 315/119; 315/185 R

(57) ABSTRACT

A light emitter diode (LED) driver drives a string of light emitting diodes. A rectifier receives an alternating current (AC) signal across two inputs and produces a direct current (DC) signal across two outputs. The two outputs are connected to ends of the string of light emitting diodes. A first capacitor is connected between a first input of the rectifier and an alternating current source. Current through the string of light emitting diodes is controlled by capacitive reactance of the first capacitor. A second capacitor is connected between the two outputs of the rectifier. A capacitive value of the second capacitor is selected to limit acoustic humming of the LED driver.

### BACKGROUND

Light emitting diode (LED) lamps, also referred to as LED bulbs, utilize light emitting diodes (LEDs). LED lamps provide long service life and high energy efficiency. An LED lamp is often arranged as LEDs with an LED driver in a package suitable to replace incandescent lamps or fluorescent lamps. The lumens of an LED lamp can be selected, for example, so that the LED can provide a similar luminosity to a particular wattage of an incandescent lamp or a fluorescent lamp that is to be replaced.

LED lamps use direct current (DC) electrical power. In order to use LED lamps with an alternating current (AC) electrical power source, rectifier circuits are used. A rectifier circuit can convert an AC signal to a DC signal at a voltage suitable for powering LED lamps. LED lamps are generally designed to operate using a low voltage (e.g., 2 to 4 volts). Heat sinks are often used to dissipate heat that can damage LED circuitry.

### BRIEF DESCRIPTION OF THE DRAWINGS

FIG. 1 is a simplified schematic of a light emitting diode (LED) driver used to drive a string of light emitting diodes (LEDs) in accordance with an embodiment.

### DETAILED DESCRIPTION

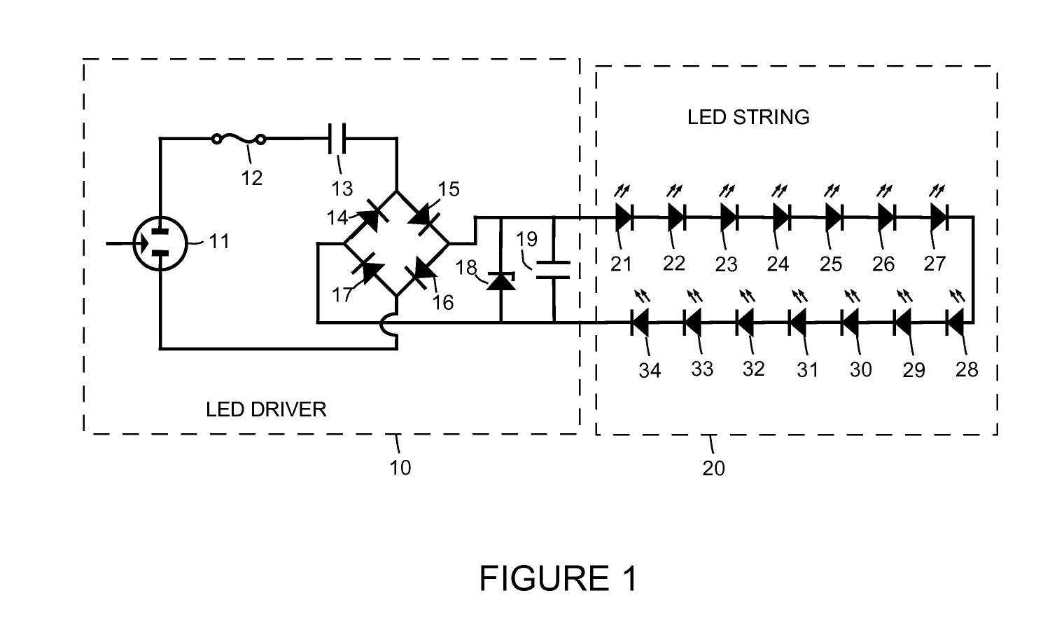

FIG. 1 is a simplified schematic of a light emitting diode (LED) driver 10 used to drive a string of light emitting diodes (LEDs) 20. In FIG. 1, LED string 20 is shown to include an LED 21, an LED 22, an LED 23, an LED 24, an LED 25, an LED 26, an LED 27, an LED 28, an LED 29, an LED 30, an LED 31, an LED 32, an LED 33 and an LED 34, serially connected as shown. The number of LEDs is only exemplary as any number, type and color of LEDs can be used. For example, each of LEDs 21 through 34 in the string of LEDS is rated for a DC current of 150 milliamps. The current and resulting voltage drop across each of LEDs 21 through 24 results in emission of light.

LED driver 10 includes an AC power source 11 and a rectifier composed of, for example a rectifier diode 14, a rectifier diode 15, a rectifier diode 16 and a rectifier diode 17, connected as shown.

Current regulation is controlled by a capacitor 13. The capacitive reactance (Xc) provided by capacitor 13 is set out in equation 1 below:

Xc=1/(2*π*f*C), Equation 1

where f is the frequency of AC power source 11 and C is the capacitance of capacitor 13. The capacitance of capacitor 13 is chosen so that the rectifier will provide the desired current through the LED string. The capacitance of capacitor 13 is selected according to the LED forward current of, as well as the equivalent resistance provided by, each LED in the LED string. This will result in the rectifier providing the desired current to and through the LED string, regardless of the number of LEDs included in the LED string.

Current (i) through the LED string can be calculated based on equation 2 below:

i=Vsource/(Xc+Rseries), Equation 2

where Vsource is equal to the voltage supplied by power source 11 and Rseries is the total equivalent resistance across all the LEDs in the LED string.

Capacitance of capacitor 13 is controlled by the negative voltage coefficient of capacitor 13 and the construction materials used to form capacitor 13. The capacitive construction materials to form capacitor 13 can be chosen so that the voltage coefficient is negative to the voltage applied across capacitor 13. When the voltage coefficient is negative to the voltage applied across capacitor 13, capacitance across capacitor 13 is increased as the voltage across capacitor 13 is decreased. This means, from equation 1, that as the voltage across capacitor 13 is increased, the capacitive reactance (Xc) across capacitor 13 is also increased (due to capacitance value increasing as voltage increases).

Careful selection of the properties of the capacitive construction materials used to construct capacitor 13 will result in the capacitive reactance across capacitor 13 to be automatically adjusted as LEDs are added or subtracted from the LED string. That is, as LEDs are added, the total equivalent resistance across all the LEDs in the LED string will increase accordingly. When the current is constant, adding to the total equivalent resistance across all the LEDs will increase the voltage drop across the LED string and correspondingly decrease the voltage drop across capacitor 13. The decreased voltage drop across capacitor 13 will result in a decrease of the capacitive reactance across capacitor 13. When the decrease of the capacitive reactance across capacitor 13 is roughly equivalent to the increase in the total equivalent resistance across all the LEDs in the LED string, then the current through the LED string will be roughly the same despite the addition of LEDs to the LED string.

Likewise, when LEDs are removed, the total equivalent resistance across all the LEDs in the LED string will decrease accordingly. When the current is constant, subtracting from the total equivalent resistance across all the LEDs will decrease the voltage drop across the LED string and correspondingly increase the voltage drop across capacitor 13. The increased voltage drop across capacitor 13 will result in an increase of the capacitive reactance across capacitor 13. When the increase of the capacitive reactance across capacitor 13 is roughly equivalent to the decrease in the total equivalent resistance across all the LEDs in the LED string, then the current through the LED string will be roughly the same despite the subtraction of LEDs from the LED string.

In this way a single design for LED driver can be used to drive LED strings of different sizes. For example, the capacitive construction materials may be a ceramic that results in a capacitor having the property that the voltage coefficient is negative to the voltage applied across the capacitor. For example, an X7R ceramic multilayer chip capacitor that provides a voltage coefficient of 0.166% of capacitance change for every 1 volt of variation on the capacitor is an example of a capacitor that is appropriate for this application.

For example, if there are thirty LEDs in the LED string and each LED has a root mean squared (RMS) forward bias current (Ifwd) of 20 milliamps (mA) and a peak (PK) Ifwd of 30 mA, capacitor 13 is selected to have a capacitance of, for example, 0.47 microfarads (μF). If each LED has an RMS Ifwd of 40 milliamps (mA) and a PK Ifwd of 60 mA, capacitor 13 is selected to have a capacitance of, for example, 1.0 μF. If each LED has an RMS Ifwd of 60 milliamps (mA) and a PK Ifwd of 90 mA, capacitor 13 is selected to have a capacitance of, for example, 1.5 μF. If each LED has an RMS Ifwd of 80 milliamps (mA) and a PK Ifwd of 120 mA, capacitor 13 is selected to have a capacitance of, for example, 2.0 μF. And so on.

When the LED string includes a low number of LEDs (e.g., less than 25 LEDs) it is often beneficial to include a transient voltage suppressor (TVS) diode 18 within LED driver 10. The reverse LED voltage is typically five volts. During turn on, for the first couple of cycles, the LED string may be placed in a reverse polarity. In the reverse polarity, the full AC input voltage will be applied to the LEDs. If the cumulative LED reverse voltage of the LED string is less than the maximum AC input outage, the LEDs will experience a reverse current, which can cause damage to the LEDs. When TVS diode 18 is included as shown in FIG. 1, TVS diode 18 will prevent breakdown reverse current across the LEDs. When there are a sufficient number of LEDs in the cumulative reverse LED voltage across the entire LED string will be sufficiently high that breakdown reverse current across the LEDs will not occur. In this case, TVS diode 18 may be omitted from LED driver 10.

For example, when there are 5 LEDs in LED string 20, the TVS value is 31 volts. When there are 10 LEDs in LED string 20, the TVS value is 62 volts. When there are 15 LEDs in LED string 20, the TVS value is 94 volts. When there are 20 LEDs in LED string 20, the TVS value is 125 volts. When there are 25 LEDs in LED string 20, the TVS value is 156 volts. In general, equation 3 below can be used to calculate the TVS value (TVSclamp) based on the reverse Led voltage (vLEDrev) and the number of LEDs (nLED):

TVSclamp=vLEDrev*nLED*(1.15). Equation 3

A capacitor 19 is included at the input of LED string 20. Capacitor 19 alleviates the affect of 120 Hz acoustic humming. A fuse 12 is also included to guard against any shorting within LED driver 10 or LED string 20. For example, fuse 12 is a 0.5 amp 125 VAC fuse.

For LEDs 21 through 24, the generated heat is an average (DC) of the peak voltage applied to LED 21 through 24. The peak voltage from the rectifier bridge is smoothed by capacitor 19. The use of the average DC voltage will produce desired lumens on the LED using less power and therefore less heat dissipation. The power dissipation on capacitor 13 is zero. Because of this the circuit generates less heat alleviating the need for a heat sink reducing weight of the circuitry and reducing cost of production.

Very little power is dissipated by capacitor 13 because current across capacitor 13 is always changing in instantaneous magnitude and direction of voltage. In general, for any given magnitude of AC voltage at a given frequency, a capacitor of given size will “conduct” a certain magnitude of AC current. The AC current through a capacitor is a function of the AC voltage across it, and the reactance offered by the capacitor. Since capacitors “conduct” current in proportion to the rate of voltage change, the reactance in ohms for any capacitor is inversely proportional to the frequency of the alternating current; the current through a capacitor is a reaction against the change in voltage across it. Therefore, the instantaneous current is zero whenever the instantaneous voltage is at a peak (zero change, or level slope, on the voltage sine wave), and the instantaneous current is at a peak wherever the instantaneous voltage is at maximum change (the points of steepest slope on the voltage wave, where it crosses the zero line). This results in a voltage wave that is −90 degrees out of phase with the current wave “P=V*I”. For further information see Tony R. Kuphaldt, “Lessons in Electric Circuits, Volume II-AC”; chapter 4—REACTANCE AND IMPEDANCE CAPACITIVE, 2013.

Due to the relatively small amount of power dissipated by capacitor 13 because of the AC current cancelation effect, a heat sink is not needed for LED driver 14. This is a significant improvement over typical LED light systems where 75% of heat is produced by the driver circuit which typically requires the presence of a heat sink to dissipate the heat produced by the driver circuit. The omission of a heat sink allows for a significant decrease in LED system weight, decreasing cost of manufacture, etc.

The embodiments discussed above allow an LED system to produce an equivalent amount of lumens to an incandescent bulb while using less than one sixth of the power required for the incandescent bulb. This is improvement over typical LED systems that produce an equivalent amount of lumens to an incandescent bulb while using about one fourth of the power required for the incandescent bulb. The embodiments discussed above allow an LED system to be implement with fewer components then typical LED systems and with no heat sink, as discussed above.

While in the discussion above, example values for the various components of LED driver 10 are given, actual values will depend on desired operation parameters for a particular application.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed is:

1. A light emitter diode (LED) driver that drives a string of light emitting diodes, the LED driver comprising:
a rectifier that receive an alternating current (AC) signal across two inputs and produces a direct current (DC) signal across two outputs, the two outputs being connected to ends of the string of light emitting diodes;
a first capacitor connected between a first input of the rectifier and an alternating current source, current through the string of light emitting diodes being controlled by capacitive reactance of the first capacitor; and
a second capacitor connected between the two outputs of the rectifier, a capacitive value of the second capacitor being selected to limit acoustic humming of the LED driver.

2. An LED driver as in claim 1 additionally comprising:
a transient voltage suppressor (TVS) diode connected between the two outputs of the rectifier.

3. An LED driver as in claim 1 additionally comprising:
a fuse connected to the alternating current source.

4. An LED driver as in claim 1 additionally comprising:
a transient voltage suppressor (TVS) diode connected between the two outputs of the rectifier; and,
a fuse connected to the alternating current source.

5. A light emitter diode (LED) light source, comprising:
a string of light emitting diodes; and
an LED driver connected to the string of light emitting diodes, the LED driver comprising:
a rectifier that receive an alternating current (AC) signal across two inputs and produces a direct current (DC) signal across two outputs, the two outputs being connected to ends of the string of light emitting diodes,
a first capacitor connected between a first input of the rectifier and an alternating current source, current through the string of light emitting diodes being controlled by capacitive reactance of the first capacitor, and
a second capacitor connected between the two outputs of the rectifier, a capacitive value of the second capacitor being selected to limit acoustic humming of the LED light source.

6. A light emitter diode (LED) light source as in claim 5, wherein the LED driver additionally comprises:
a transient voltage suppressor (TVS) diode connected between the two outputs of the rectifier.

7. A light emitter diode (LED) light source as in claim 5, wherein the LED driver additionally comprises:
a fuse connected to the alternating current source.

8. A light emitter diode (LED) light source as in claim 5, wherein the LED driver additionally comprises:
a transient voltage suppressor (TVS) diode connected between the two outputs of the rectifier; and,
a fuse connected to the alternating current source.

9. A method for driving a string of light emitting diodes, the method comprising:
rectifying an alternating current (AC) signal to produces a direct current (DC) signal across two outputs of a light emitting (LED) driver circuit;
controlling current through the string of light emitting diodes by capacitive reactance of a first capacitor; and
limiting acoustic humming of the LED driver circuit by use of a second capacitor connected between the two outputs of the LED driver circuit, wherein capacitive value of the second capacitor is selected to limit the acoustic humming.

10. A method as in claim 9 additionally comprising:
guarding against breakdown reverse current across the string of light emitting diodes by a transient voltage suppressor (TVS) diode connected between the two outputs of the rectifier.

11. A method as in claim 9 additionally comprising:
guarding against shorts by a fuse connected to the alternating current source.

12. A method as in claim 9 additionally comprising:
guarding against breakdown reverse current across the string of light emitting diodes by a transient voltage suppressor (TVS) diode connected between the two outputs of the rectifier; and,
guarding against shorts by a fuse connected to the alternating current source.
